(19) United States
(12) Patent Application Publication
(10) Pub. No.: US 2025/0240357 A1
(43) Pub. Date: Jul. 24, 2025

(54) SYSTEM AND METHOD FOR MANAGING TRANSPORTATION OPERATIONS AND PROVIDING COMMUNICATIONS HUB

(71) Applicant: Quality Drive Away, Goshen, IN (US)

(72) Inventors: William James Martin, JR., Goshen, IN (US); Thomas Franklin Smith, Osceola, IN (US); Arthur James Hicks, JR., Goshen, IN (US); Angela Blough, Middlebury, IN (US)

(21) Appl. No.: 18/418,586

(22) Filed: Jan. 22, 2024

(51) Int. Cl. H04L 69/18; G06Q 50/40; H04L 67/12

(52) U.S. Cl. CPC H04L 69/18; G06Q 50/40; H04L 67/12

(57) ABSTRACT

A system for managing vehicle data and facilitating user communication across a vehicle supply chain includes an enterprise system comprised of a server, software, and a central repository. The enterprise system also includes a plurality of user channels including a user channel for each of an original equipment manufacturer (OEM), a supplier, and a consumer. A multi-protocol communication hub provides or communicates with a standardized data interface for the plurality of user channels to access the enterprise system. The standardized data interface includes or communicates with a searchable interface to the central repository. The central repository includes vehicle data for a plurality of vehicles of the vehicle supply chain, where each of the plurality of vehicles is assigned a unique vehicle identifier in the central repository. The multi-protocol communication hub facilitates user communication among users of the user channels.

### TECHNICAL FIELD

The present disclosure relates generally to a system and method for tracking and managing transportation operations and providing a communications hub for various users of the system.

### BACKGROUND

Transportation companies are faced with moving a variety of different freight for a variety of different customers between multiple locations. Tracking and managing such operations, including for example, management of drivers, customers, orders, vehicles, and trips, can be challenging. Accordingly, it is important that the transportation companies strive to schedule the movement of freight in an effective and efficient manner to provide a high-quality service.

Further, managing inventory for manufacturers and dealers and providing consumers with high quality operations and services can also be challenging.

The present novel technology addresses this need.

### SUMMARY

In one aspect of the present disclosure, a system for managing vehicle data and facilitating user communication across a vehicle supply chain includes an enterprise system comprised of a server, software, and a central repository. The enterprise system also includes a plurality of user channels including a user channel for each of an original equipment manufacturer (OEM), a supplier, and a consumer. A multi-protocol communication hub provides or communicates with a standardized data interface for the plurality of user channels to access the enterprise system. The standardized data interface includes or communicates with a searchable interface to the central repository. The central repository includes vehicle data for a plurality of vehicles of the vehicle supply chain, where each of the plurality of vehicles is assigned a unique vehicle identifier in the central repository. The multi-protocol communication hub facilitates user communication among users of the user channels.

### BRIEF DESCRIPTION OF THE DRAWINGS

The described embodiments and other features, advantages and disclosures contained herein, and the manner of attaining them, will become apparent and the present disclosure will be better understood by reference to the following description of various embodiments of the present disclosure taken in conjunction with the accompanying drawings, wherein:

FIG. 1 shows a simplified diagram of an exemplary transportation management system for carrying out the functionality of the systems and method of the present disclosure;

FIGS. 2, 3, 4 show different screen captures of an end-user device for a driver, displaying details of trips assigned or otherwise associated with the driver;

FIGS. 5, 6, 7, 8 show different screen captures of the end-user device for a driver, displaying available trips;

FIGS. 9, 10 show different screen captures of the end-user device for a driver, displaying the selection and request of an available trip;

FIGS. 11, 12, 13 show different screen captures of the end-user device for a driver, displaying order details and a checklist of tasks to be complete prior to starting the trip;

FIGS. 14, 15, 16 show different screen captures of the end-user device for a driver, displaying options available for the driver during a trip;

FIGS. 17, 18 show different screen captures of the end-user device for a driver while competing a trip, including facilitating a final inspection;

FIG. 19 shows a flow diagram illustrating a method for stopping a trip in progress;

FIG. 20 shows a flow diagram illustrating a method for abandoning a trip;

FIGS. 21, 22, 23, 24 show different screen captures of the end-user device for a driver, displaying an option to add additional documents while a trip is in progress or after a trip is completed;

FIGS. 25, 26, 27 show different screen captures of the end-user device for a driver, displaying an option to add additional documents, including delivery documents or photos, for inspection;

FIGS. 28, 29, 30 show different screen captures of the end-user device for a driver, displaying an option for processing settlement documents, including receipts;

FIG. 31 shows a screen capture of the end-user device for a driver, illustrating settlement documents approval;

FIG. 32 shows another screen capture of the end-user device for a driver, illustrating settlement documents approval;

FIGS. 33, 34, 35, 36 show different screen captures of the end-user device for a driver, displaying a screen for completing a trip and submitting delivery documents;

FIGS. 37, 38, 39 show screen captures 308, 310, 312 of the end-user device for a driver, displaying real-time tracking locations;

FIG. 40 shows dashboard 320, providing real-time stats;

FIG. 41 shows a simplified diagram of an exemplary system for carrying out the functionality of systems and methods of the present disclosure; and

FIG. 42 shows a screen capture of a display, displaying transportation vehicle component status information, according to an aspect of the present disclosure.

In the figures, the same features are identified by the same reference signs.

### DETAILED DESCRIPTION

Before the present methods, implementations, and systems are disclosed and described, it is to be understood that this invention is not limited to specific implementations, and as such may, of course, vary. It is also to be understood that the terminology used herein is for the purpose of describing particular implementations only and is not intended to be limiting.

As used in the specification and the claims, the singular forms “a,” “an,”, and “the” include plural references unless the context clearly dictates otherwise. Ranges may be expressed in ways including from “about” one particular value, and/or to “about” another particular value. When such a range is expressed, another implementation may include from the one particular value and/or to the other particular value. Similarly, when values are expressed as approximations, for example by use of the antecedent “about,” it will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not Similarly, “typical” or “typically” means that the subsequently described event or circumstance often occur or often not occur, and that the description includes instances where said event or circumstance occurs and instances where it does not.

As used herein, a computer implemented method refers to a method which involves the use of a computer, computer network or other programmable apparatus, where one or more features are realized wholly or partly by means of a computer program. A non-transitory computer-readable storage medium refers to a medium having stored thereon software instructions that, when executed by a processor, cause the processor to generate control signals for executing predetermined steps.

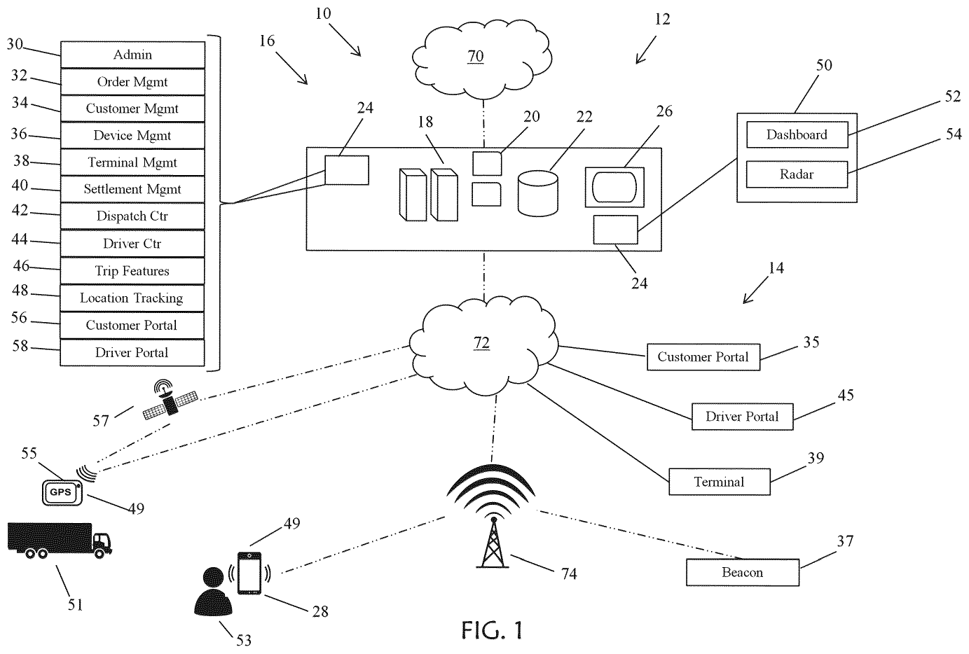

Depicted in FIG. 1 is a block diagram of a transportation management system 10, including a computer system 12, according to the present disclosure. The transportation management system 10 and method, in an exemplary embodiment, are configured to facilitate interactive communication between management drivers, and customers of a transportation system. The transportation management system 10, portions of which may be referenced herein as the computer system 12, including a plurality of different components.

The computer system 12 may generally include what is referred to as a front-end and a back-end 16. The back-end 16 may generally include one or more servers 18, processors 20, databases 22, modules 24 and displays 26. The back-ends 16 refer to parts of a computer application or a program's code that allow it to operate and that cannot be accessed by a user. Most data and operating syntax are stored and accessed in the back-end 16 of the computer system 12. Typically, the code is comprised of one or more programming languages.

Server 18 is a computer or system that provides resources, data, services, or programs to other computers over a network. The server 18 may include or utilize the one or more processors 20. A central processing unit, also called a central processor, main processor or just processor (20), is the electronic circuitry that executes instructions comprising a computer program. The CPU 20 performs basic arithmetic, logic, controlling, and input/output operations specified by the instructions in the program. The data storage module 22 may include memory for storing data and images, and instructions that are processed by the one or more processors 20.

The transportation management system 10 may include or use one or more modules 24 to perform various functions including, but not limited to, searching, analyzing, querying, interfacing, etc. A “module” refers to a portion of the computer system 12 and/or software program that carries out one or more specific functions and may be used alone or combined with other modules 24 or the same system or program.

For example, a module 24 may be located on the transportation management system 10 (e.g., on the servers 18 of the transportation management system, i.e., server-side module), on end user devices 28, or on an intermediary device (e.g., the client server, i.e., a client-side module; another end user device(s); a different server on the network; or any other machine capable of direct or indirect communication with, for example, systems, websites, and/or the end user devices 28).

According to an exemplary embodiment, the transportation management system 10 may include the following modules 24:

An administration module 30 may provide or include the following functionality: staff management; ability to send invites, change passwords, assign roles, list of inactive users; manage roles and assign permissions; list of all responses that will get sent upon various triggers; ability to create or edit response as needed; and management of important account settings affecting all areas of the system.

An order management module 32 may provide or include the following functionality: create and edit orders; ability to manage orders submitted by customers; sortable views of all open orders; ability to open each order for more details including trip map and nearby orders; and record of bill of ladings (BOL's) that are being sent automatically and ability to download or rerun.

A customer management module 34 may provide or include the following functionality: upper-level account management, user management, viewable as bill to's, order to's, consignees, or all, manage customers utilizing a customer portal 35; invite new users, assign consignees, reset passwords; and log in as ability to see a customer's portal view.

A device, or beacon 37, management module 36 may provide or include the following functionality: complete list of available and registered tracking devices; ability to setup available devices; ability to create zones to surround the area's devices are assigned to; live tracking of all devices; and alarm notifications when device leaves or enters a zone. System may also automatically detect zones visited to document history of possible places visited within geo zones specified through the administration module.

A notification center provides a centralized hub for all emails, SMS, Push, and Chat activity throughout the platform. It provides the ability to schedule, review, and monitor communication activity across their terminal/inventory management module 38 may provide or include the following functionality: manage all terminals 39 utilized by a transportation company; manage lots available at each terminal 39; and ability to import inventory from customer.

Rate management provides advanced algorithms to estimate customer charges, and driver pay based on conditional order criteria. Rates can be linked, cloned, and distributed internally and across other enterprise environments.

A settlement module 40 may provide or include the following functionality: see all trips that have been completed; approve or reject documentation photo provides by the driver; ability to converse with the driver; follow the history of all documented photos; location sending on photos to ensure they were captured within a mile radius of delivery location; ability to classify and record expenses from the photo, will transfer automatically to a trip expense sheet; and can add additional, non-photo expenses to trip expense sheet; shows all trips that have final approval from a settlements department; ability to download all documents that have been captured; trip expense sheet is attached so all driver pay can be settled appropriately; ability to pay driver; and once settled trip can be marked to move to invoicing.

A dispatch center module 42 may provide or include the following functionality: various views of open orders and load boards presented to drivers; ability to open each order for more details including trip map and nearby orders; ability to create trip plans; ability to assign drivers to trips; ability to start, stop abandon, hold, or split an order; and ability to give to give driver advances or withdrawals.

A driver center module 44 may provide or include the following functionality: at a glance counts of active/inactive drivers and devices drivers are using: searchable list of all drivers; individual drivers; driver equipment, safe miles, authorizations, and pay set up and management; ability to export driver data to Excel; manage drivers utilizing the driver portal 45, send login invite, change password; log in as any driver to see their driver portal view; list of all drivers that have enrolled in the driver portal 45; manage all the necessary documents drivers need available on the driver portal 45; ability to download copies as necessary; ability to manage driver employers; and ability to manage company owned equipment utilized by drivers.

A radar, or location tracking module 48, described in greater detail below, may provide or include the following functionality: a plurality of tracking devices 49, which may be associated with transport vehicles 51, drivers 53, orders, etc.; real-time tracking; use of a GPS 55 and satellite 57 to determine location; display live data for trips that are currently active; visibility of all check calls; map showing the location of active trips; record all data associated with the trip; and hot links to full driver and order details.

A display module 50 may provide or include a graphical user interface for displaying, for example, dashboard 52 and/or radar 54. The dashboard 52, according to the exemplary embodiment, may display stats for the driver counts, trip requests, trip statuses dwell ratings, trip priorities, and trip ranks with clickable views that take you to compiled lists of the metric representation. The radar 54 may show live data for trips that are currently active and/or a list of tracking devices 49, and a map showing the locations of all active devices 49.

A customer portal module 56 may provide or include the following functionality, which may be accessed via the customer portal 35: interactive chart to view orders by status, order volume chart; view list of orders according to preferred filters, ability to export order list, and view individual orders for further details; instructional videos for various activities; and manage the users you want to have access to your account.

A driver portal module 58 may provide or include the following functionality, which may be accessed via the driver portal 45: review of taxable earnings, pay stubs and earnings statements bonds summary, mileage summary; annual safety review training, documentation drivers may need to download; list of certifications and expiration dates; list of trips available to be moved; and requesting a trip.

The transportation management system 10 may additionally or alternatively include a cloud-based system 70. Cloud-based networking is referred to as the network communication and interconnectivity between IT resources/application within a cloud computing infrastructure. It may include a processor and data storage and enables a cloud computing solution/service to interact and perform network connection with other resources on the cloud 70. Any cloud-based solution refers to applications, storage, on-demand services, computer networks, or other resources that are accessed with an Internet connection through another provider's shared cloud computing framework.

The layer above the back-end 16, described above, is the front end 14 and it includes all software or hardware that is part of a user interface. Human or digital users interact directly with various aspects of the front end 14 of a program, including user-entered data, buttons, programs, website and other features, may include one or more hardware processors 20, or central processing units, for executing one or more programs and controlling operations of one or more components consistent with the teachings herein.

The user 53 may install a program to interface with a system server to communicate data, interactions, and information to/from the user's end user device(s), such as via the internet 72 and/or another wireless communication network 74. In some other implementations, the system may be installed on a user's machine and operate, in whole or in part, independently of system WAN and/or LAN components. For example, the system software may be deployed to a user's computer as a standalone program that interfaces with the user's computer, creates and maintains data store(s), maintains/processes subscriptions data, maintains/processes trust linkage data, filters/transfers email, etc.

A device or other component of the transportation management system 10 of the present disclosure may comprise any combination of hardware and/or software that may interact and perform the functionality described herein. Exemplary hardware may include, without limitation, desktops or other computers (e.g., tablets, slates, etc.), database servers, network storage devices and other network devices, smart phones and other cell phones.

The end user device or mobile device 28 may include one or more hardware processors, or central processing units, for executing one or more programs and controlling operations of one or more components consistent with the teachings herein. The mobile device 28 also includes a communications module, which facilitates communications between components between components within and/or outside the mobile device 28. The components between components within and/or outside the mobile device 28. The components of the mobile device 28, and even the transportation management system 10, in general, may include or utilize multiple interacting computer systems or devices and may be connected to other devices that are not specifically illustrated, including via Bluetooth communication or other direct communication, through one or more networks such as the Internet 72, via the Web, or via one or more private networks (e.g,. mobile communication networks, etc.).

Although an exemplary transportation management system 10 has been described, implementations of the subject matter and the functional operations described in the specification may be implemented in other types of digital electronic circuitry, or in the computer software, firmware, or hardware, including the structures disclosed in this specification and their structural equivalents, or in combination of one or more of them.

Embodiments of the subject matter and the operations described in this specification may be implemented as a method, in digital electronic circuitry, or in computer software, firmware, or hardware, including the structures disclosed in this specification and their structural equivalents, or in combination of one or more of them. Embodiments of the subject matter described in this specification may be implemented as one or more computer programs, that is, one or more modules of computer program instructions encoded on computer storage medium for execution by, or to control the operation of, data processing apparatus.

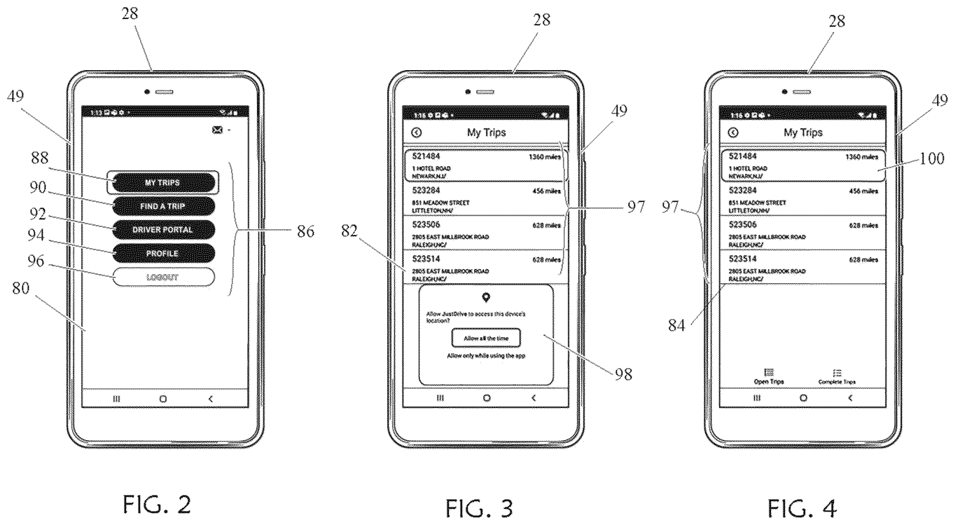

FIGS. 2, 3, 4 show different screen captures 80, 82 and 84 of an end-user device 28 for the driver 53, displaying details of trips assigned or otherwise associated with the driver 53. For example, with reference to FIG. 2, the driver 53 may be presented with a menu 86 facilitating selection of “my trips” 88, “find a trip” 90, “driver portal” 92, “profile” 94, and “logout” 96. By selecting “my trips” 88, the driver 53 may be provided with a list 97 of trips assigned or associated with the driver 53. On various screens, such as that shown in FIG. 3, the driver 53 may be given the option, via a pop-up window 98 to allow the underlying program or application to access the location of the user device 28. In FIG. 4, is an illustration of the selection of a particular trip 100 to drill down and gain additional details regarding the trip 100.

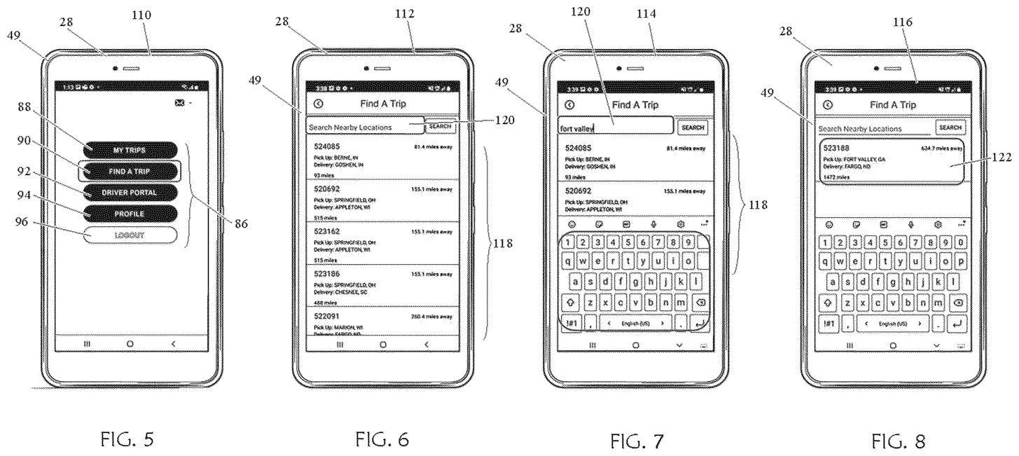

FIGS. 5, 6, 7, 8 show different screen captures 110, 112, 114 and 116 of the end-user device 28 for the driver 53, displaying available trips. By selecting “find a trip” 90, the driver 53 may be provided with a list 118 of available trips for the driver 53. In FIG. 7, the driver 53 may enter search criteria at 120 to find specific trips. A selection may then be made at 122 of FIG. 8 to select a particular trip.

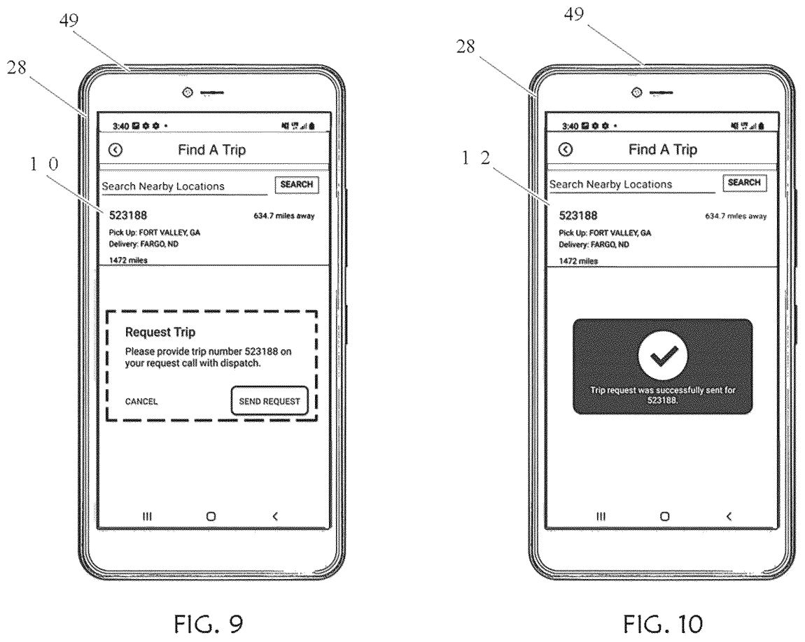

FIGS. 9, 10 show different screen captures 130 and 132 of the end-user device 28 for the driver 53, displaying the selection and request of an available trip, as shown in FIG. 9. Thereafter, the driver 53 may receive a confirmation that the request was successfully, as shown in FIG. 10.

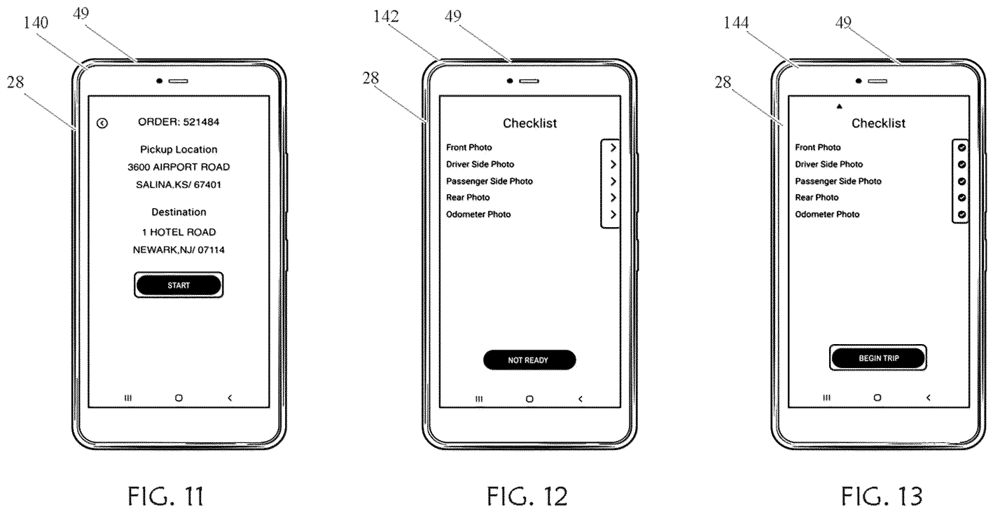

FIGS. 11, 12, 13 show different screen captures 140, 142, 144 of the end-user device 28 for a driver 53, displaying order details and a checklist of tasks to be completed prior to starting the trip. FIG. 11 shows details of the order, while FIGS. 12 and 13 depict checklists of items to be completed by the driver 53 prior to starting the trip.

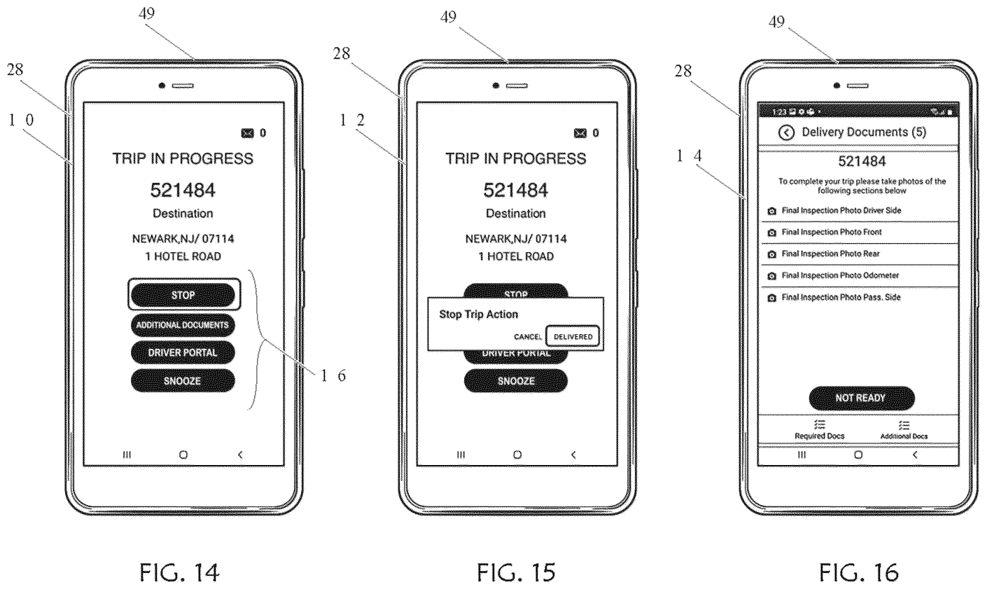

FIGS. 14, 15, 16 show different screen captures 150, 152 and 154 of the end-user device 28 for a driver 53, displaying options available for the driver during a trip. Options available, at 156 include: “stop,” “additional documents,” “driver portal,” and “snooze.” In FIG. 15, it can be seen that driver 53 may select an option to reflect a delivered status. After indicating a trip as completed, the driver 53 may be given the option to enter, or upload, delivery documentation, which may include photos.

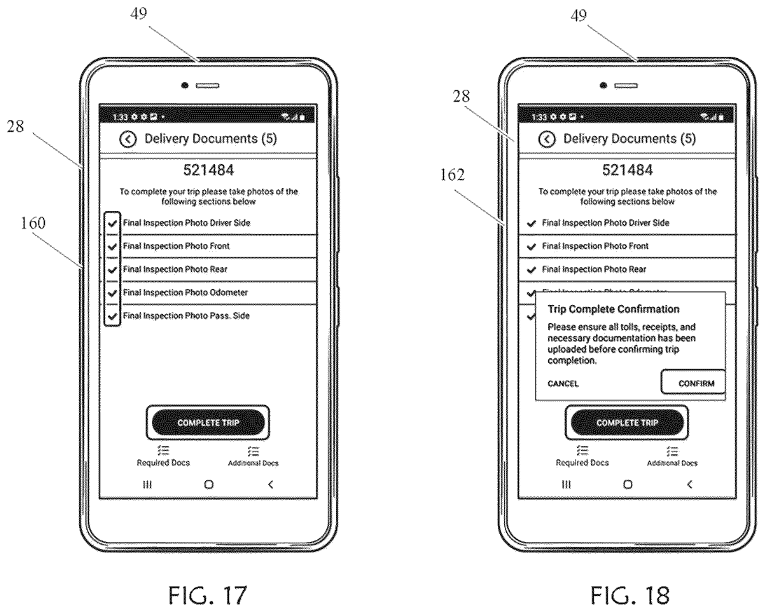

FIGS. 17, 18 show different screen captures 160 and 162 of the end-user device 28 for a driver 53 while completing a trip, including facilitating a final inspection. That is, the driver 53 may enter required documentation, used for a final inspection, prior to completing a trip.

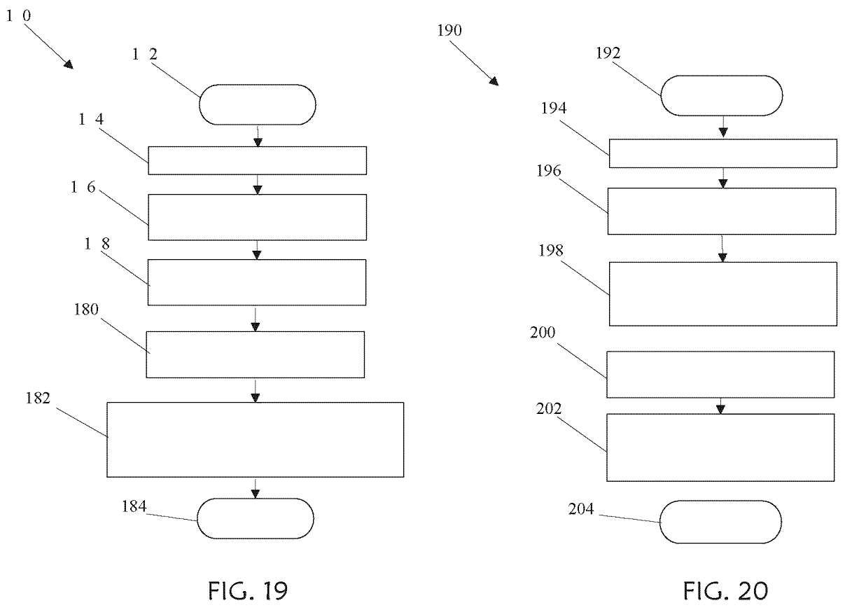

FIG. 19 shows a flow diagram 170 illustrating a method for stopping a trip in progress. The method begins at a stat (box 172) and, after a trip is manually stopped through the application (box 174), the trip is moved to completed trips (176). The trip will behave as normal when a trip is stopped (box 178). The driver 53 will receive a notice of trip status confirmation, box 180, and the driver will not deliver any required delivery documents, but can add receipts for settlement, box 182. The method proceeds to an end at box 184.

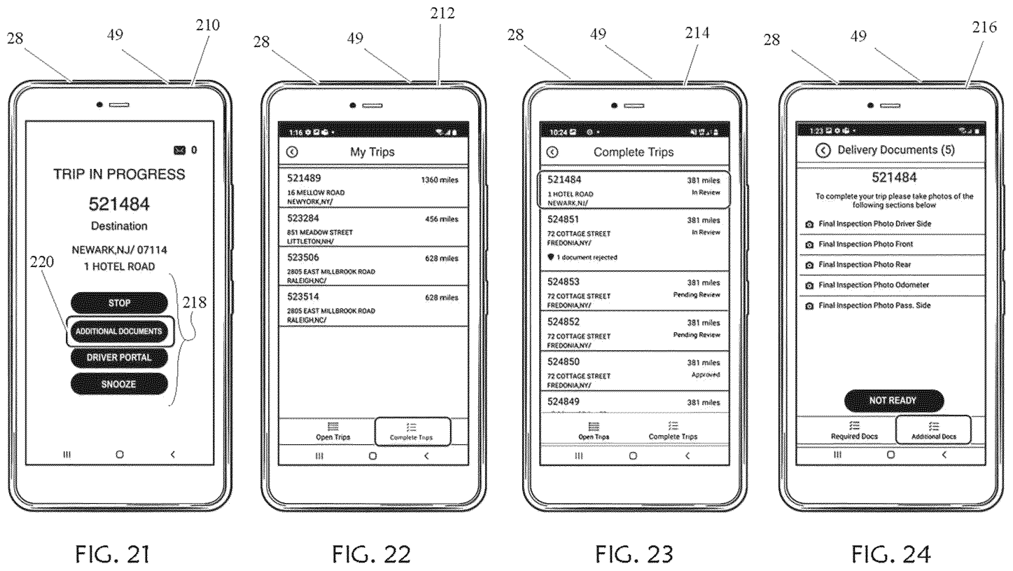

FIG. 20 shows a flow diagram 190 illustrating a method for abandoning a trip, starting at box 192. A trip may be abandoned in dispatch, at box 194. In response, the trip will be removed from active trips (box 196) and will be reverted back to PLN status and started trip boxes will uncheck (box 198). At box 200, the driver 53 will receive notice of a trip status confirmation, and, at box 202, the trip will be closed out and preliminary photos will be removed. The method proceeds to an end at box 204.

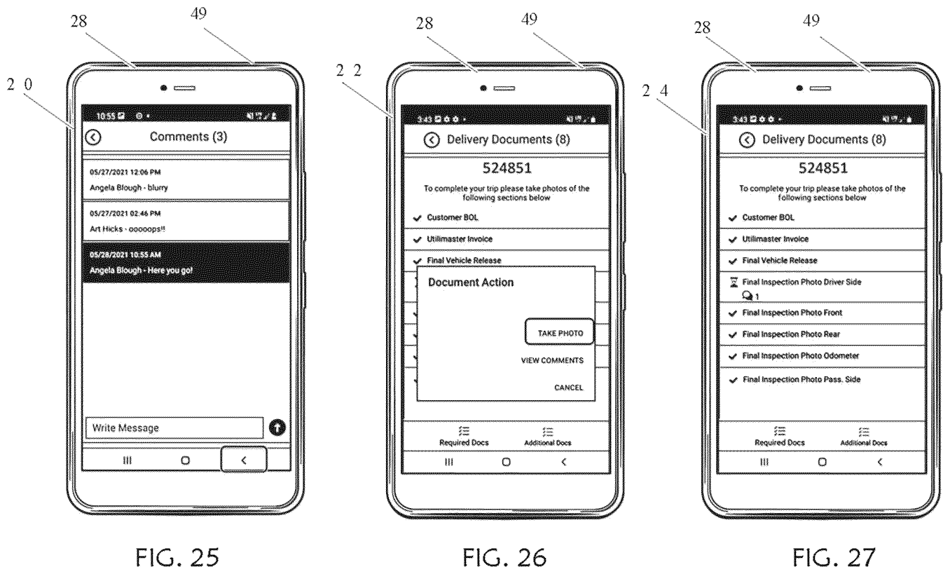

FIGS. 21, 22, 23, 24 show different screen captures 210, 212, 214 and 216 of the end-user device 28 for a driver 53, displaying an option to add additional documents while a trip is in progress or after a trip is completed. Specifically, in FIG. 21, the driver 53 is presented with menu options, at 218, including an option to add documents at 220. The driver 53 is then directed to a list of the driver's 53 trips. The driver 53 may select a trip, from either completed trips or open trips, as shown in FIG. 22. After selecting completed trips, for example, the list is filtered to include only completed trips of the driver 53. After the driver 53 selects a completed trip (FIG. 23), details of the selected trip are displayed at FIG. 24 and the driver 53 may choose the option for additional documents, such as receipts, inspection documents, and settlement documents.

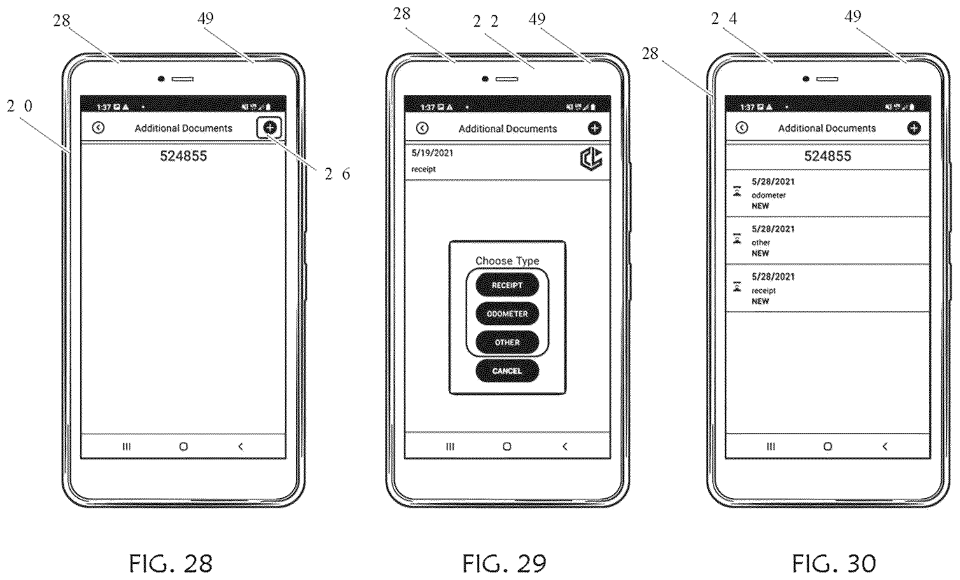

FIGS. 25, 26, 27 show different screen captures 230, 232 and 234 of the end-user device 28 for a driver 53, displaying an option to add additional documents, including delivery documents or photos, for inspection. As shown in FIG. 25, the driver 53 can communicate with another user of the system regarding the submission of documents. In particular, communication regarding whether or not documents are acceptable may be communicated and the driver 53 may be prompted to submit a document again. As shown in FIG. 26, the driver 53 may take a photo from the end-user device 28 and submit it through the system. The status of the documents, with respect to acceptance or rejection, are displayed in FIG. 27.

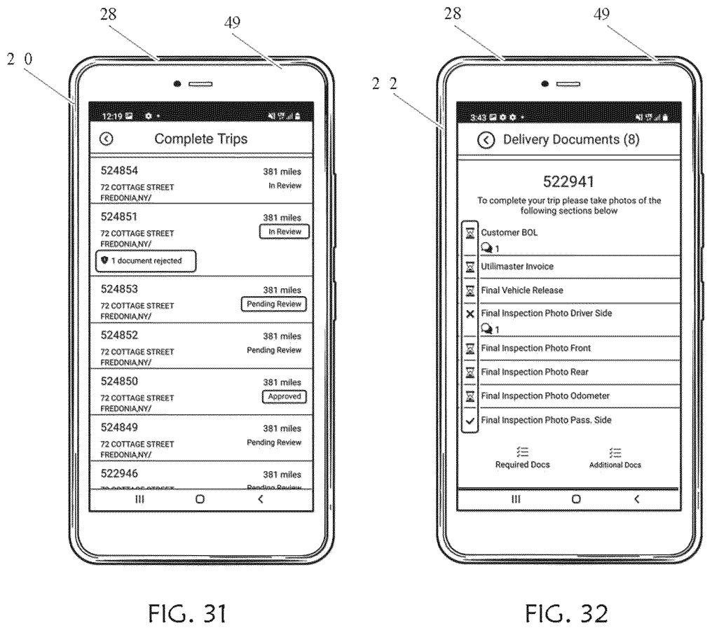

FIGS. 28, 29, 30 show different screen captures 250, 252 and 254 of the end-user device 280 for a driver 53, displaying an option for processing settlement documents, including receipts. For a particular trip, an option may be given, such as at 256, to add documents to the trip. At FIG. 29, the type of “document” may be selected for entry, with FIG. 30 showing the line entry for each type of document.

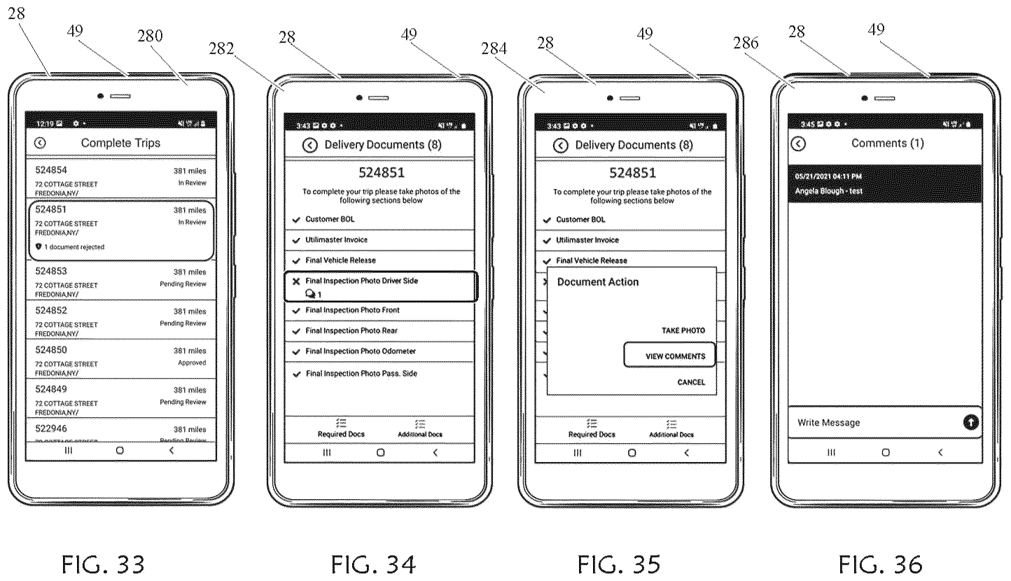

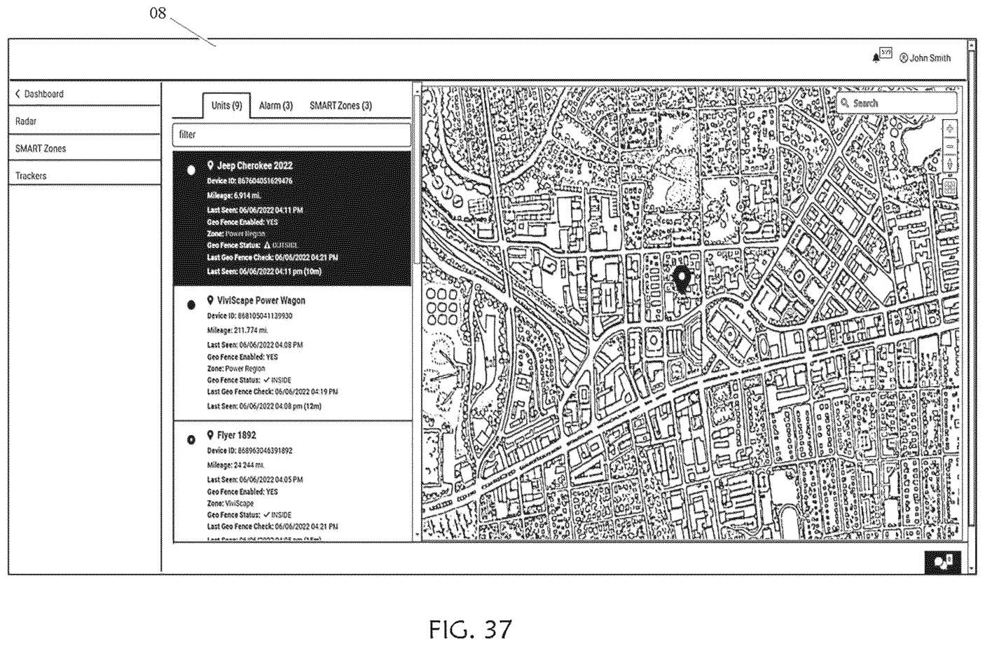

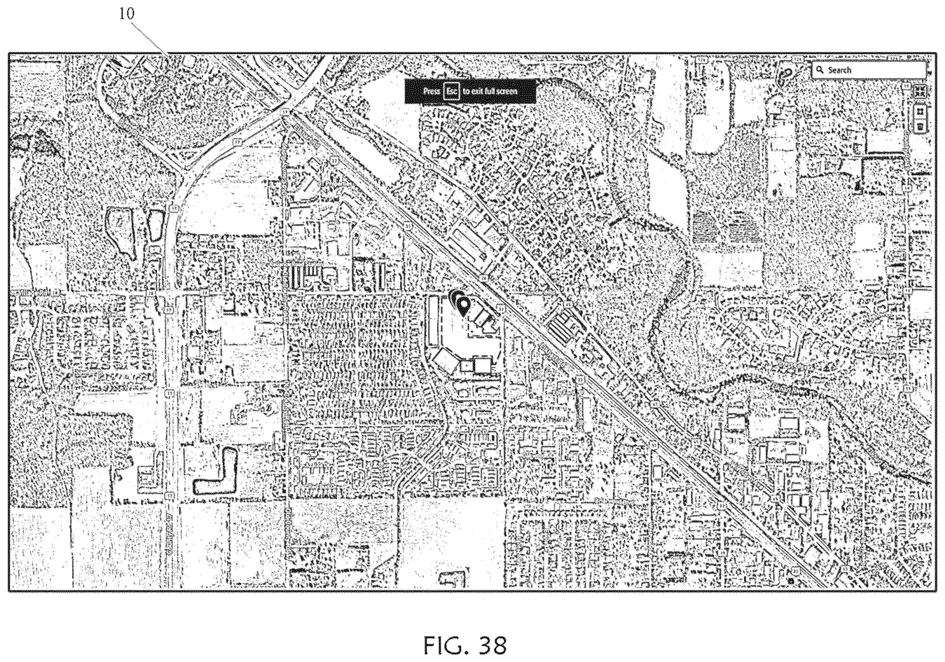

FIGS. 31 and 32 show screen captures 270 and 272 of the end-user device 28 for a driver 53, illustrating settlement documents approval. In particular, FIG. 31 shows the status of the documentation for completed trips, while FIG. 32 shows the status of document submissions for a particular completed trip. FIGS. 33, 34, 35, 36 show different screen captures 280, 282, 284 and 286 of the end-user device 28 for a driver 53, displaying a process for completing and submitting delivery documents that have been rejected. Delivery documents may be displayed after selecting a completed trip from a list of trips (FIG. 33). At FIGS. 34 and 35 a document entry that is flagged may be selected to view. Comments associated with the entry may be viewed at FIG. 36.

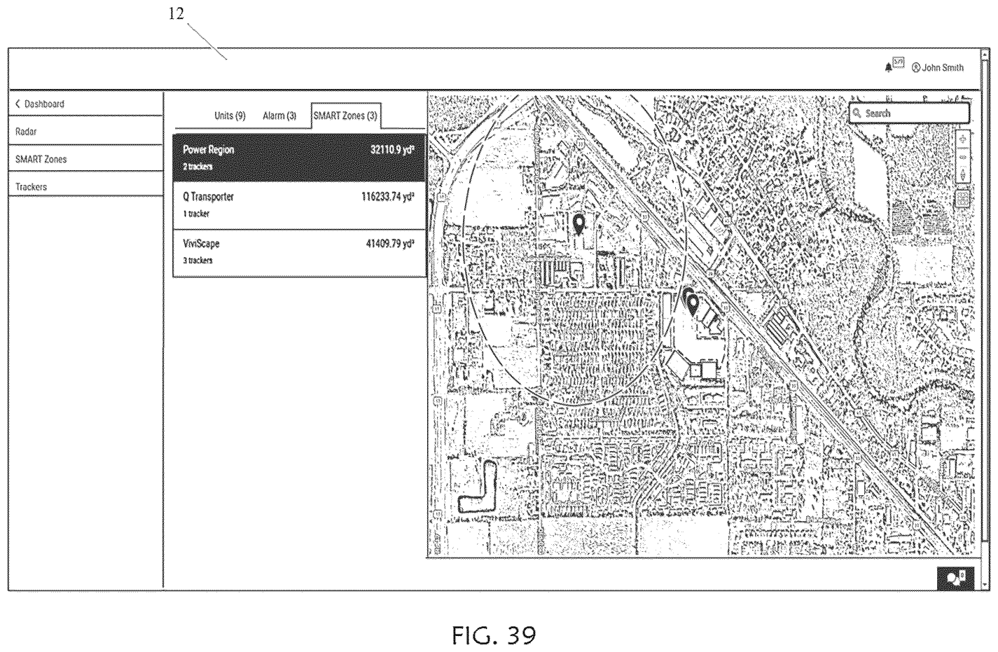

FIGS. 37, 38 and 39 show screen captures displaying real-time tracking locations on a radar 308, 310 and 312. The view on the respective radars may be toggled to show active trips, or change views using other filters. Details of particular trips may be displayed.

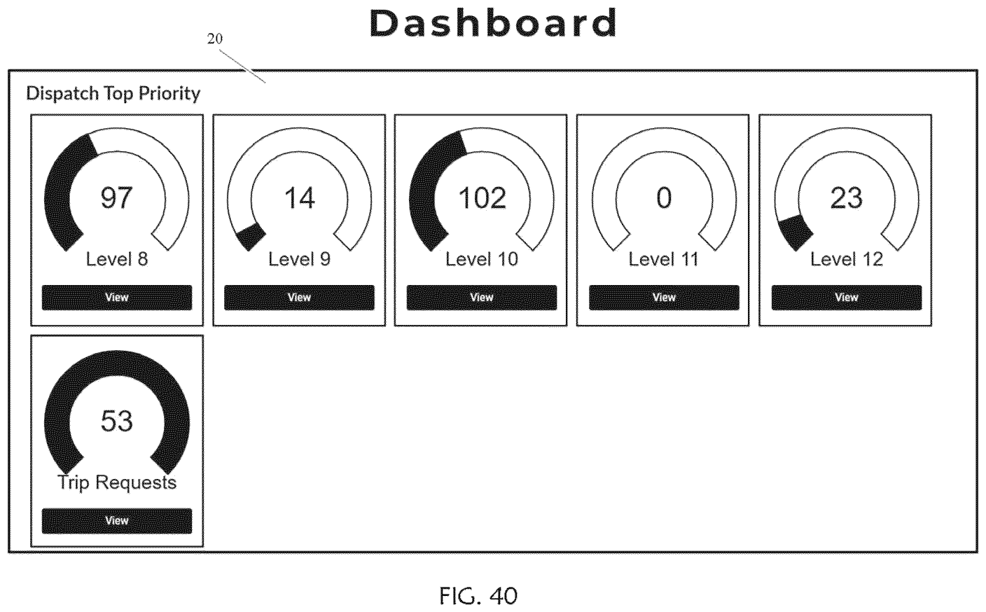

FIG. 40 shows a screen capture 320 of the end-user device 28 for a driver 53, displaying a dashboard of real-time data generated by the present disclosure. It presents a drill down menu of various stats.

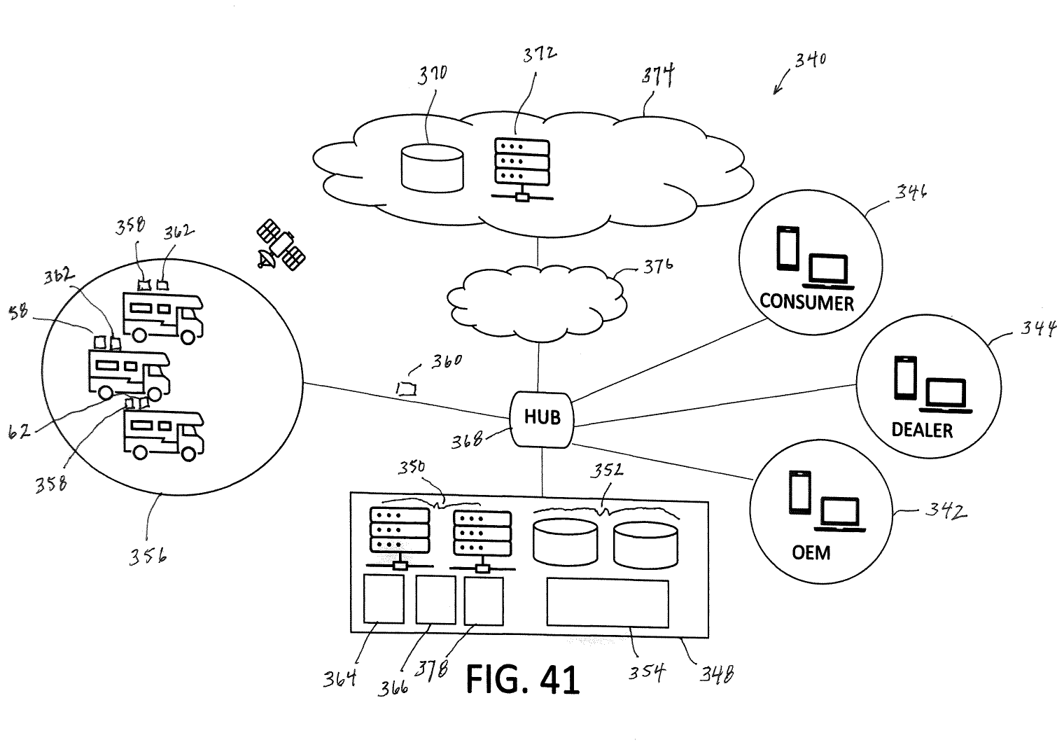

Another embodiment of the present disclosure is illustrated as system 340 in FIG. 41. The system 340 is used generally for tracking and managing vehicle data and facilitating user communication across a vehicle supply chain. For example, the system 340 is configured to facilitate interactive communication, via user channels, between and among various users, such as, for example, manufacturers (OEMs) 342, dealers 344, consumers 346, and sometimes drivers (described above). The system 340 includes a back-end system, or enterprise system, 348, which includes one or more servers 350, software, and one or more central repositories, or databases, 352, and a front-end, which includes interfaces for accessing the system 340. The server 350, or, more particularly, an enterprise server, includes modules for carrying out the functionality of the systems and methods described herein. The system 340 may also include and execute any of the other modules described above.

The enterprise system 348 may control a display 354 depicting real-time location tracking of vehicles, or transportation vehicles, 356 using location tracking devices 358, which each include a GPS utility, and real-time tracking of vehicle data, or vehicle component data, 360 using a plurality of remote monitoring devices 362 supported on the vehicle 356. Information provided may also include accident detection, vehicle diagnostics, and speed monitoring, for example. The vehicle 356 is depicted as a recreational vehicle; however, the vehicle 356 may be another vehicle being transported or a transportation vehicle for transporting freight or may be a vehicle 356 at the location of a manufacturer, dealer, or consumer, or may be in transit.

The plurality of remote monitoring devices 362 may include any of a variety of different sensors, such as, for example, proximity sensors, pressure sensors, temperature sensors, position sensors, flow and level sensors, image sensors, gas detectors, humidity sensors, accelerometers, tilt sensors, vibration sensors, and/or various other devices positioned to gather various component data from the vehicle 356.

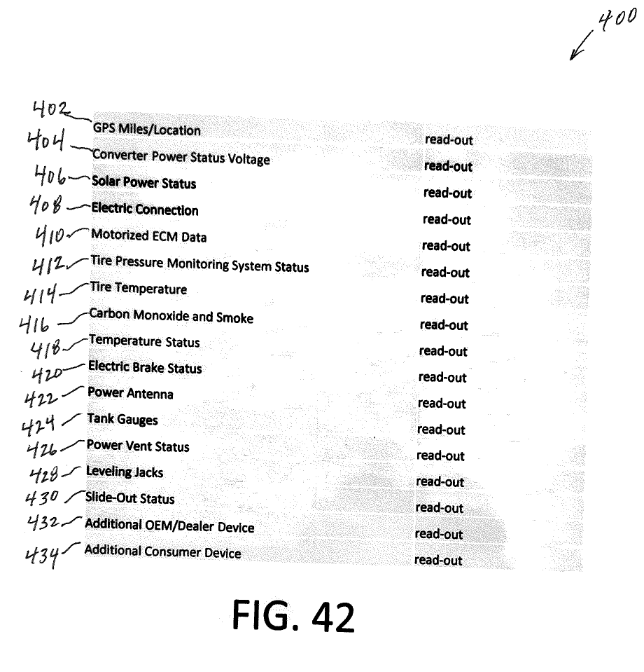

Exemplary data 360 captured for the exemplary vehicle 356 is described below and presented in a table 400 in FIG. 42.
GPS miles/location (402): the location and the mileage of the transportation vehicle.
Converter power status voltage (404): the status of the power inverter.
Solar power status (406): the status of the solar inverter.
Electric connection (408): the analog voltage.
Motorized-ECM data (410): power to the ECM; parameters such as diagnostic trouble codes, values from engine sensors, etc.
Tire pressure monitoring system status (412): tire pressure on valve stems.
Tire temp (414): tire temperature.
Carbon monoxide and smoke (416): carbon monoxide and smoke-status and/or power.
Temperature status (418): temperature-status and/or power.
Electric brake status (420): voltage and amperage at the brakes.
Power antenna (422): electrical power and status.
Tank gauges (water, grey, black, LP. generator fuel) (424): tank level sensors.
Power vent status (426): electrical power and status.
Leveling jacks (428): electrical power and status.
Slide out status (430): electrical power, status/position.
Additional OEM/Dealer Device (432): device configured to access the server and database and communicate with other users of the system.
Additional Consumer Device (432): device configured to access the server and database and communicate with other users of the system.

This vehicle data 360 may be displayed on the display 354 and/or may be displayed separately or in conjunction with the real-time location tracking of the vehicle 356, such as in embodiments discussed above, for example. The amount of data 360 and the organization of data 360 on the display 354 may be customized based on user preferences. The system 340 may also include a dashboard 364 and/or radar 366 displaying vehicle information, or information related to the trip and/or driver. Thus, the display 354 may depict a comprehensive view of transportation operations and vehicle data 360. The vehicle data 360 may correspond to a plurality of vehicles or only vehicles corresponding to unique vehicle identifiers.

A multi-protocol communications hub 368 provides or communicates with a standardized data interface for a plurality of user channels, which may be wired or wireless, to access the enterprise system 348. The standardized data interface includes or communicates with a searchable interface to the central repository 352. The central repository 352 includes vehicle data for a plurality of vehicles 356 of the vehicle supply chain, where, as mentioned above, each of the plurality of vehicles 356 is assigned a unique vehicle identifier in the central repository 352. The multi-protocol communication hub 368 facilitates user communication among users 342, 344, 346 of the user channels.

The communication hub 364 is a multi-protocol hub, supporting multiple communications protocols, including various wireless protocols, that can connect multiple devices through one platform. That is, the communications hub 368 may collect and translate various protocol communications from the different devices of various users. For example, some common protocols may include Bluetooth Connectivity, WiFi, the Internet and Cellular services.

Enterprise software of the back-end system 348 provides the functionality described herein and supports communications between the users of the system 340, via the hub 368. The software also facilitates access to the one or more databases 352. The system 340 may also use application and infrastructure resources, including one or more databases 370 and one or more servers 372, in the cloud 374, via the internet 376.

Manufacturers 342 can access finished goods data and dealer inventory data, including transportation vehicle data 360, which may be stored in the one or more central repositories, or databases, 352. Manufacturers 342 may also integrate results of quality control inspections and system checks into the system 340. Dealers 344 may also conduct inspections and store resulting data in the databases 352. This data provided by manufacturers 342 and dealers 344 can provide service data that may be accessed by all users of the system 340.

Consumers 346 can use the system 340 to provide monitoring and management of the vehicle 356 based on information provided by the sensors 362 located on or in the vehicle 356. Monitoring can provide information about the status of the vehicle 356 and equipment on or in the vehicle 356. The information provided by the sensors 362 and the formulated feedback information may be stored in memory on the transportation vehicle 356 as well as in the databases 352. The real-time location tracking data or real-time component status data for vehicles 356 may also be sent to users through the hub 368 and the user channels.

A vehicle component module 348 is configured to facilitate access to the database 346 housing vehicle component data 366 and other related data. The vehicle component data 366 may include an organized and profiled central repository 352 of all component data for user reference. The database 346 may store production data and quality control documentation corresponding to the vehicle 354 and, more particularly, components of the vehicle 354. This documentation may include data defined by a quality management system and may be reflective of quality standards and operational procedures.

For each of the plurality of vehicles 356, the central repository 352 may store the unique vehicle identifier, an identification of standard equipment that is installed on the particular vehicles 356, and an identification of non-standard equipment that is installed on the particular vehicle 356. The central repository 352 may also provide a centralized location of maintenance records for each vehicle 356 and a centralized location of component documentation for each vehicle 356.

The system 340 also includes software and hardware that is part of a front-end or user interface, providing access to functionality of the system 340 and to the database 352 by the users. Human or digital users interact directly with various aspects of the front-end, including user-entered data, buttons, programs, websites and other features, and may include one or more hardware processors, or central processing units, for executing one or more programs and controlling operations of one or more components consistent with the teachings herein.

Devices or other components of the system 340 of the present disclosure may comprise any combination of hardware and/or software that may interact and perform the functionality described herein. Exemplary hardware may include, without limitation, desktops or other computers (e.g., tablets, slates, etc.), database servers, network storage devices and other network devices, smart phones and other cell phones.

According to the exemplary embodiment, any of the users may install an app to interface with the system server 350 to communicate data, interactions, and information to/from the user's end user device(s), such as via the internet and/or another wireless communication network. In some other implementations, the system software may be installed on a user's machine and operate, in whole or in part, independently of system WAN and/or LAN components. For example, the system software may be deployed to a user's computer as a standalone program that interfaces with the user's computer, creates and maintains data store(s), maintains/processes subscriptions data, maintains/processes trust linkage data, filters/transfers email, etc.

In particular, the users may have an app installed on an end user device, such as a mobile device. The end user device may include one or more hardware processors, or central processing units, for executing one or more programs and controlling operations of one or more components consistent with the teachings herein. The mobile device also includes a communications module, which facilitates communications between components within and/or outside the end user device. The system 340 may also provide access to various users via portals. The portals may provide web-based access to one or more repositories of the system 340, including database 352.

The system 340 may include a chatbot 378, trained using artificial intelligence, which interfaces with the database 352 and understands spoken or written human language based on natural language processing (NPL) capabilities. The chatbot 378 determines the intent of a query that a user enters and provides what it determines to be the most appropriate response. This can make it easier for users to find the particular content they are searching for in the database 352 by responding to questions and requests, such as through text, audio input, or both, without the need for human intervention.

When a transportation vehicle 356 is sold, a consumer 346 may purchase a subscription for additional services, including, for example, monitoring and securing GPS location, mobile internet (mi-fi), wi-fi, and streaming services. The consumer can also purchase a subscription for direct access to service and technical expertise.

The database 352 may include information regarding manufacturer installed components (e.g., refrigerator, stove, self-leveling jacks, furnace, water heater, entertainment systems, water pumps, and other components) and may also include information regarding additional components added or installed for particular transportation vehicles 356. Additional components may include, for example, a camera door bell, blue tooth entertainment features, security monitoring, and pet containment systems.

The hub 368 can connect the consumer 346, dealer 344 and manufacturer 342 to all data regarding particular builds to provide a resource for knowledge and maintenance to assist the consumer 346 with questions. This aids in offering consumer information specific to the components integrated into the product. This can also assist in addressing specific product issues prior to a service appointment, thus saving service times at the dealer 344 and reducing down time to consumers 346 for use of the product.

It should be appreciated that the system 340 may include numerous devices interconnected via the hub 368, providing various channels of communication between various users of the system.

The operations described in this specification may be implemented as operations performed by a data processing apparatus on data stored on one or more computer-readable storage devices or received from other sources.

1. A system for managing vehicle data and facilitating user communication across a vehicle supply chain, including:
an enterprise system including a server, software, and a central repository;
a plurality of user channels including a user channel for each of an original equipment manufacturer (OEM), a supplier, and a consumer; and
a multi-protocol communication hub providing or communicating with a standardized data interface for the plurality of user channels to access the enterprise system;
wherein the standardized data interface includes or communicates with a searchable interface to the central repository;
wherein the central repository includes vehicle data for a plurality of vehicles of the vehicle supply chain, wherein each of the plurality of vehicles is assigned a unique vehicle identifier in the central repository;
wherein the multi-protocol communication hub facilitates user communication among users of the user channels.

2. The system of claim 1, wherein real-time location tracking data or real-time component status data for vehicles is sent to users through the hub and the user channels.

3. The system of claim 2, wherein the real-time tracking is provided by a location tracking device including a GPS utility supported on the vehicle.

4. The system of claim 2, wherein the real-time component status data is provided by real-time monitoring devices supported on the vehicle.

5. The system of claim 1, wherein the plurality of user channels are wired or wireless.

6. The system of claim 1, wherein the enterprise system is cloud-based.

7. The system of claim 1, wherein the central repository stores inspection and system check results for each of the plurality of vehicles.

8. The system of claim 1, wherein the central repository, for each of the plurality of vehicles, stores the unique vehicle identifier, an identification of standard equipment that is installed, and an identification of non-standard equipment that is installed.

9. The system of claim 8, wherein the central repository provides a centralized location of maintenance records for each vehicle.

10. The system of claim 8, wherein the central repository provides a centralized location of component documentation for each vehicle.

11. The system of claim 1, further including an artificial intelligence trained chatbot interfacing with the central repository.
